(19) United States
(12) Patent Application Publication
(10) Pub. No.: US 2006/0056740 A1
(43) Pub. Date: Mar. 16, 2006

(54) Apparatus and method for editing moving image data

(75) Inventor: Eizaburo Muraki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Personal Products, Ltd., Tokyo (JP)

(21) Appl. No.: 11/224,040

(22) Filed: Sep. 13, 2005

(30) Foreign Application Priority Data
Sep. 14, 2004 (JP) 267343/2004

(51) Int. Cl. G06K 9/03

(52) U.S. Cl. 382/309

(57) ABSTRACT

A control unit displays an operation screen representing a plurality of moving image data on a display unit. The control unit specifies the first moving image data for each of the plurality of moving image data displayed on the operation screen. Editing time taken to edit a plurality of the moving image data is shortened, and the reproduction time in reproducing and displaying the moving image data is shortened.

### BACKGROUND OF THE INVENTION

1. Field of the Invention

The present invention relates to a moving image editing apparatus and method for editing the moving image data.

2. Description of the Related Art

An editing apparatus is known which stores the moving image data of a telecast program with the undesired moving image data such as commercials, advertisements, etc. as a recorded program in a storage unit (e.g., hard disk recorder), and edits the moving image data stored in the storage unit into the moving image data desired by the user such as program content. The moving image data stored in the storage unit may contain alternately the moving image data desired by the user (desired moving image data) and the moving image data other than the desired moving image data (undesired moving image data). In this case, the user arranges the first to last desired moving image data by operating the editing apparatus to edit the moving image data. Thereby, the reproduction time when the edited moving image data is reproduced and displayed on the display unit is shorter than the reproduction time when the moving image data is reproduced and displayed on the display unit. However, the operation for editing the moving image data is monotonous and inefficient.

In Japanese Patent Laid-Open No. 2004-140750, an image editing apparatus that can edit image data easily from simple editing of deleting a shot or rearranging data to slightly high level editing of post-recording or screen effect insertion is disclosed. This image editing apparatus comprises pick-up means for picking up a plurality of moving image signals, first display means for displaying a plurality of representative images that are still images representing each of the plurality of moving images associated with an identification number of each moving image, second display means for displaying an input screen for inputting the identification numbers arranged in a desired order to set up the order of arranging the plurality of moving images, input means for inputting the identification numbers arranged in the desired order on the input screen, and editing means for editing moving images arranged in the order of identification numbers inputted on the input screen.

However, this conventional system just discloses the rearrangement of a plurality of moving image data in a specified order. It does not relate those moving image data to each other, nor specify desired or undesired moving image data all together. Therefore, the conventional system does not shorten the editing time or the reproduction time for the plurality of moving image data.

### SUMMARY OF THE INVENTION

In view of the foregoing and other exemplary problems, drawbacks, and disadvantages, it is an exemplary feature of the invention to provide a moving image editing apparatus that can shorten the editing time taken to edit a plurality of the moving image data and shorten the reproduction time in reproducing and displaying the moving image data.

Other exemplary purposes, features and advantages of the invention will be apparent to those skilled in the art from the following description of the exemplary embodiments.

The present invention provides a method and an apparatus for editing moving image data. This method and apparatus include displaying an operation screen representing the plurality of moving image data on the display unit, and specifying first moving image data for each of the plurality of moving image data displayed on the operation screen.

The first and second moving image data correspond to undesired moving image data and desired moving image data respectively, or vice versa. The following description mainly explains the case that the first and second moving image data should correspond to undesired moving image data and desired moving image data, respectively. The similar explanation essentially applies to the case that the first and second moving image data should correspond to desired moving image data and undesired moving image data, respectively.

With the method and apparatus, the editing time for editing the moving image data is shortened, and the reproduction time for reproducing and displaying the moving image data is shortened.

### BRIEF DESCRIPTION OF THE DRAWINGS

These and other purposes, features and advantages of the invention will become more fully apparent from the following detailed description taken in conjunction with accompanying drawings.

FIG. 1 shows the configuration of an exemplary moving image editing apparatus of the present invention;

FIG. 2 shows the contents stored in a storage unit 3 for the moving image editing apparatus of the invention;

FIG. 3 shows the configuration of a control unit 1 for the exemplary moving image editing apparatus of the invention;

FIG. 4 is a diagram for explaining the concept of a simple editing process and a high level editing process in the exemplary moving image editing apparatus of the invention;

FIG. 5 is a diagram for explaining the concept of the simple editing process and the high level editing process in the exemplary moving image editing apparatus of the invention;

FIG. 6 is a diagram for explaining the concept of the simple editing process and the high level editing process in the exemplary moving image editing apparatus of the invention;

FIG. 7 is a flowchart showing the operation of the exemplary moving image editing apparatus of the invention;

FIG. 8 is a flowchart showing the simple editing process (S5) as the operation of the exemplary moving image editing apparatus of the invention;

FIG. 9 is a flowchart showing the simple editing process (S5) as the operation of the exemplary moving image editing apparatus of the invention;

FIG. 10 shows an operation screen 30 in the exemplary moving image editing apparatus of the invention;

FIG. 11 shows the operation screen 30 in the exemplary moving image-editing apparatus of the invention;

FIG. 12 shows the operation screen 30 in the exemplary moving image editing apparatus of the invention;

FIG. 13 shows the operation screen 30 in the exemplary moving image editing apparatus of the invention;

FIG. 14 shows the operation screen 30 in the exemplary moving image editing apparatus of the invention;

FIG. 15 is a flowchart showing the high level editing process (S6) as the operation of the exemplary moving image editing apparatus of the invention;

FIG. 16 is a flowchart showing the high level editing process (S6) as the operation of the exemplary moving image editing apparatus of the invention;

FIG. 17 shows the operation screen 30 in the exemplary moving image editing apparatus of the invention;

FIG. 18 shows the operation screen 30 in the exemplary moving image editing apparatus of the invention;

FIG. 19 shows the operation screen 30 in the exemplary moving image editing apparatus of the invention;

FIG. 20 shows the operation screen 30 in the exemplary moving image editing apparatus of the invention;

FIG. 21 is a view for explaining the exemplary moving image editing apparatus of the invention; and

FIG. 22 is a view for explaining the exemplary moving image editing apparatus of the invention.

### DESCRIPTION OF THE EXEMPLARY EMBODIMENTS

With reference to the drawings, a detailed description will be given of the best modes for implementing the present invention.

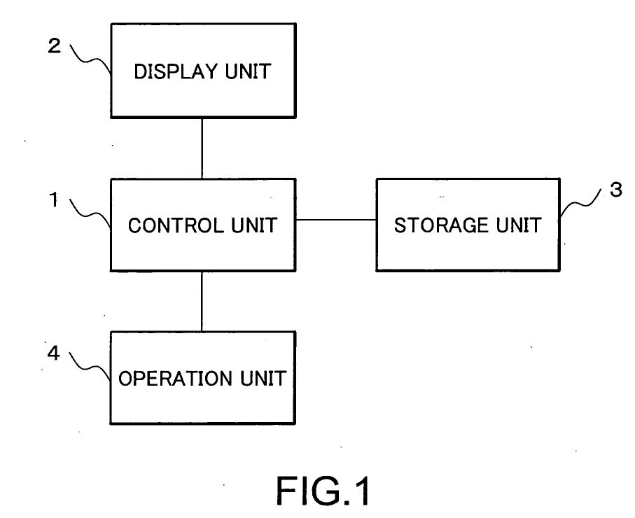

FIG. 1 shows the configuration of a moving image editing apparatus of the invention. The moving image editing apparatus of the invention includes a control unit 1, a display unit 2, a storage unit 3 and an operation unit 4. The control unit 1 is connected to the display unit 2, the storage unit 3 and the operation unit 4. Also, the control unit 1 is provided with a speaker (not shown) for outputting a sound. The storage unit 3 may be a hard disk recorder, for example. The operation unit 4 is composed of a keyboard, a pointing device, and a remote control (remote controller).

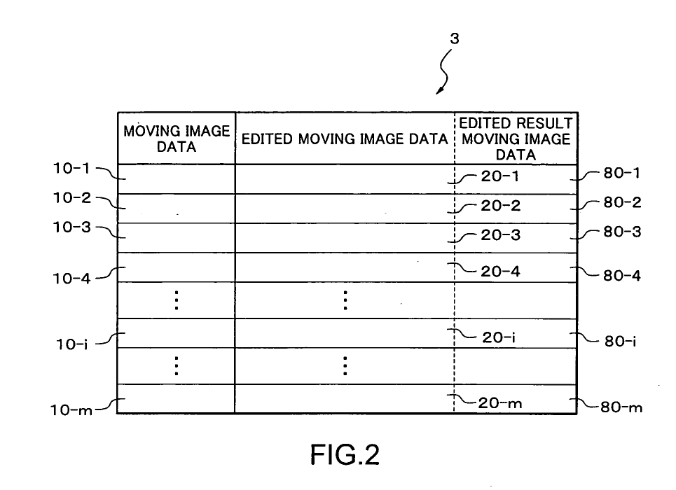

FIG. 2 shows the contents stored in the storage unit 3 for the moving image editing apparatus of the invention. The storage unit 3 stores a plurality of moving image data 10-1 to 10-m (m is an integer greater than or equal to 1) that are telecast. The moving image data 10-1 to 10-m are recorded data of the program broadcast on television. The moving image data 10-i (i=1, 2, 3, 4, . . . , m) is composed of a file name (program name) attached to identify the moving image data 10-i, a plurality of frames of image data, the recording time when recording the first to last frames of image data, and sound waveform data representing the sound in waveform. Some of the moving image data such as program content of a television broadcast are desired by the user, while the rest of them are not, such as a commercial, advertisement, etc. The present invention enables the user to specify either desired moving image data or undesired moving image data.

The following explanation is based on the case to specify the undesired moving image data. Although the case to specify the desired moving image data is not shown in detail, the similar explanation is essentially applied. When the moving image data 10-i is edited, the storage unit 3 stores the moving image data 10-i with undesired moving image data specified as the edited moving image data 20-i. At this time, the edited result moving image data 80-i other than the undesired moving image data is stored as the reproduction moving image data for the edited moving image data 20-i.

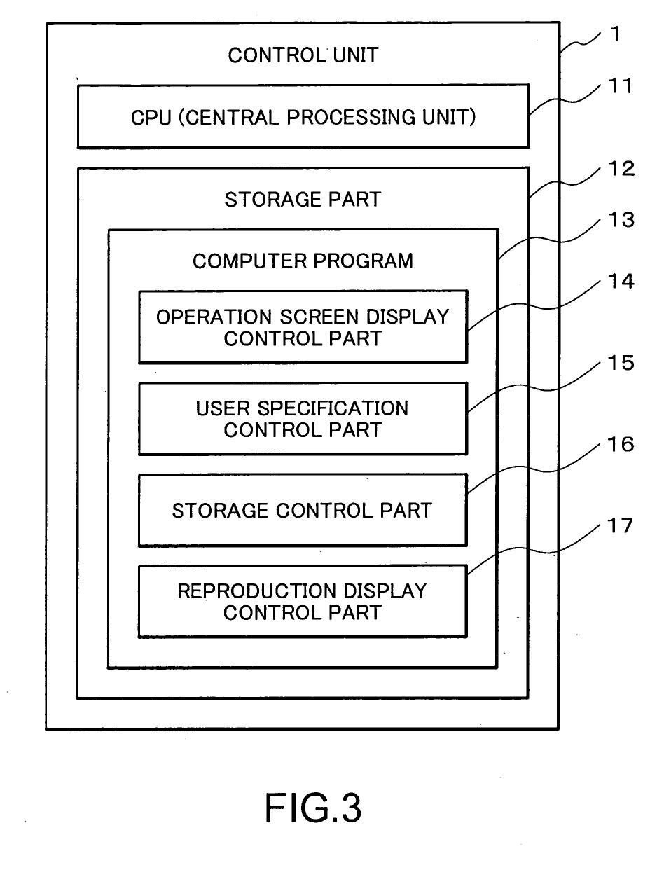

FIG. 3 shows the configuration of the control unit 1 for the moving image editing apparatus of the invention. The control unit 1 is a computer comprising a CPU (Central Processing Unit) 11 and a storage part 12. The storage part 12 stores a computer program to be executed by the CPU 11. The computer program 13 includes an operation screen display control part 14, a user specification control part 15, a storage control part 16, and a reproduction display control part 17.

When the user edits the moving image data 10-1 to 10-4, the operation screen display control part 14, the user specification control part 15, and the storage control part 16 perform a simple editing process or a high level editing process in accordance with a user's instruction from the operation unit 4. The operation screen display control part 14, the user specification control part 15, and the storage control part 16 can be implemented in other ways, e.g. circuits, instead of a computer program. The variations should be understood by those skilled in the art from the following descriptions of the embodiment. The concept of the simple editing process and high level editing process will be described below.

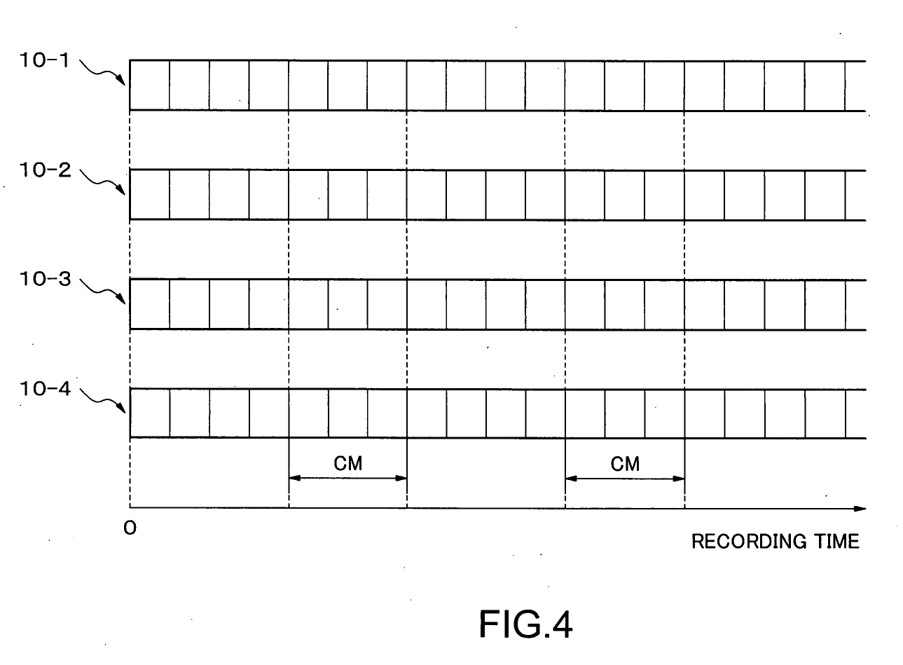

First of all, as a precondition, the moving image data 10-1 to 10-4 stored in the storage unit 3 is a recorded program telecast from the same broadcasting station periodically in the same slot. For example, the moving image data 10-1 to 10-4 stored in the storage unit 3 are programs broadcast in the same slot on the same day of week, and supposed to be recorded data when a program for the first week, a program for the second week, a program for the third week and a program for the fourth week are recorded. The moving image data 10-1 to 10-4 have the program names of “recorded program A”, “recorded program B”, “recorded program C” and “recorded program D”¹. Each of the moving image data 10-1 to 10-4 contains a part of moving image data judged to be undesired by the user, for example, a commercial (CM), in which the slot for broadcasting the commercial is almost the same, as shown in FIG. 4.

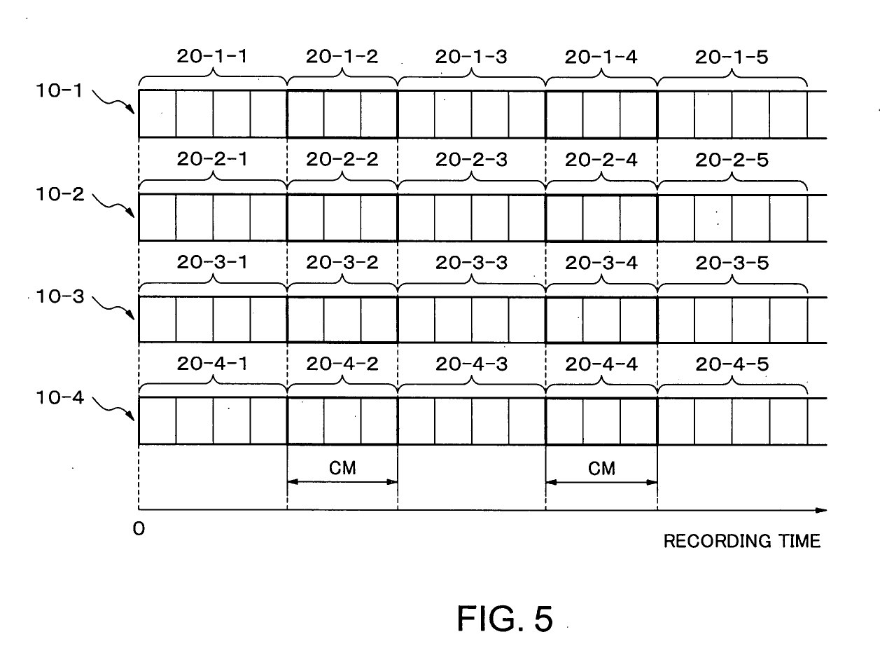

With the simple editing process or the high level editing process, the edited moving image data 20-1-1 to 20-1-n (n is an integer great than or equal to 2), 20-2-1 to 20-2-n, 20-3-1 to 20-3-n, and 20-4-1 to 20-4-n are generated. When the moving image data 10-1, 10-2, 10-3, 10-4 are represented by a plurality of candidate moving image data 20-1-1 to 20-1-n, 20-2-1 to 20-2-n, 20-3-1 to 20-3-n, and 20-4-1 to 20-4-n, respectively, FIG. 5 illustrates the case that the even-numbered candidate moving image data are the moving image data judged to be undesired.

For the sake of convenience, n is assumed to be an even number in the following explanation, but when n is an odd number, the same explanation essentially applies. Also, m is assumed to be 4, but the same explanation applies for any other integer greater than or equal to 1.

Referring to FIG. 5, the concept of the simple editing process will be described below. The simple editing process is optimal when the user unfamiliar with the computer edits the moving image data 10-1 to 10-4.

The user issues a simple editing process instruction to the control unit 1, employing the operation unit 4. At this time, the operation screen display control part 14 of the control unit 1 recognizes that the simple editing process is performed in response to the simple editing process instruction of the user. Then, the user issues an image display instruction to the control unit 1, employing the operation unit 4. The operation screen display control part 14 displays an operation screen representing the moving image data 10-1 to 10-4 stored in the storage unit 3 on the display unit 2, in response to the image display instruction of the user.

The user issues an adjustment instruction to the control unit 1, employing the operation unit 4. At this time, the user specification control part 15 of the control unit 1 specifies the undesired moving image data for each of the moving image data 10-1 to 10-4 displayed on the operation screen in (n/2) times in response to the adjustment instruction of the user. For example, with the first adjustment instruction, the user sorts the candidate moving image data 20-1-2, 20-2-2, 20-3-2, 20-4-2 from each of the moving image data 10-1, 10-2, 10-3, 10-4 and specifies them as the first undesired moving image data.

Then, with the second adjustment instruction, the user sorts the candidate moving image data 20-1-4, 20-2-4, 20-3-4, 20-4-4 from each of the moving image data 10-1, 10-2, 10-3, 10-4 and specifies them as the second undesired moving image data. The user repeats the above process until all undesired moving image data are specified.

The user issues a store instruction to the control unit 1, employing the operation unit 4. At this time, the storage control part 16 of the control unit 1 stores the moving image data 10-1 to 10-4 with the undesired moving image data specified as the edited moving image data 20-1 to 20-4 in the storage unit 3 in response to a store instruction of the user. At this time, the edited result moving image data 80-1 to 80-4 other than the undesired moving image data are stored as the reproduction moving image data of the edited moving image data 20-1 to 20-4 in the storage unit 3.

The editing time for editing each of the moving image data 10-1, 10-2, 10-3, 10-4 through the simple editing process is shorter than the editing time for editing only the moving image data 10-1. In this case, since four moving image data are edited at a time, the editing time is shortened into ¼. In this way, with the moving image editing apparatus of the invention, the editing time is shortened through the simple editing process.

Referring to FIG. 5, the concept of the high level editing process will be described below. The high level editing process is optimal when the user familiar with the computer edits the moving image data 10-1 to 10-4.

The user issues a high level editing process instruction to the control unit 1, employing the operation unit 4. At this time, the operation screen display control part 14 of the control unit 1 recognizes that the high level editing process is performed in response to the high level editing process instruction of the user. Then, the user issues an image display instruction to the control unit 1, employing the operation unit 4. The operation screen display control part 14 displays an operation screen representing the moving image data 10-1 to 10-4 stored in the storage unit 3 on the display unit 2, in response to the image display instruction of the user.

The user issues an adjustment instruction to the control unit 1, employing the operation unit 4. At this time, the user specification control part 15 of the control unit 1 specifies the undesired moving image data at a time for each of the moving image data 10-1 to 10-4 displayed on the operation screen in response to the adjustment instruction of the user. The adjustment instructions include a sorting adjustment instruction and an area specification adjustment instruction. For example, with the sorting adjustment instruction, the user sorts the candidate moving image data 20-1-1 to 20-1-n, 20-2-1 to 20-2-n, 20-3-1 to 20-3-n, 20-4-1 to 20-4-n from each of the moving image data 10-1, 10-2, 10-3, 10-4.

Then, with the area specification adjustment instruction, the user specifies one candidate moving image data (even-numbered candidate moving image data in this embodiment) out of the odd-numbered candidate moving image data and the even-numbered candidate moving image data, as the undesired moving image data, among the candidate moving image data 20-1-1 to 20-1-n, 20-2-1 to 20-2-n, 20-3-1 to 20-3-n, 20-4-1 to 20-4-n.

The user issues a store instruction to the control unit 1, employing the operation unit 4. At this time, the storage control part 16 of the control unit 1 stores the moving image data 10-1 to 10-4 with the undesired moving image data specified as the edited moving image data 20-1 to 20-4 in the storage unit 3 in response to a store instruction of the user. At this time, the edited result moving image data 80-1 to 80-4 other than the undesired moving image data are stored as the reproduction moving image data of the edited moving image data 20-1 to 20-4 in the storage unit 3.

After the operation screen display control part 14, the user specification control part 15 and the storage control part 16 perform the simple editing process or the high level editing process, the user issues a first edited moving image data reproduction instruction to the control unit 1, employing the operation unit 4.

At this time, the reproduction display control part 17 of the control unit 1 selects the edited moving image data 20-1 among the edited moving image data 20-1 to 20-4 stored in the storage unit 3 in response to the first edited moving image data reproduction instruction of the user, and reproduces and displays the edited result moving image data 80-1 as the reproduction moving image data of the edited moving image data 20-1 on the display unit 2.

That is, the moving image data 20-1-1, 20-1-3, 20-1-5, . . . , 20-1-(n−1) other than the undesired moving image data are reproduced and displayed as the odd-numbered candidate moving image data among the edited moving image data 20-1 on the display unit 2.

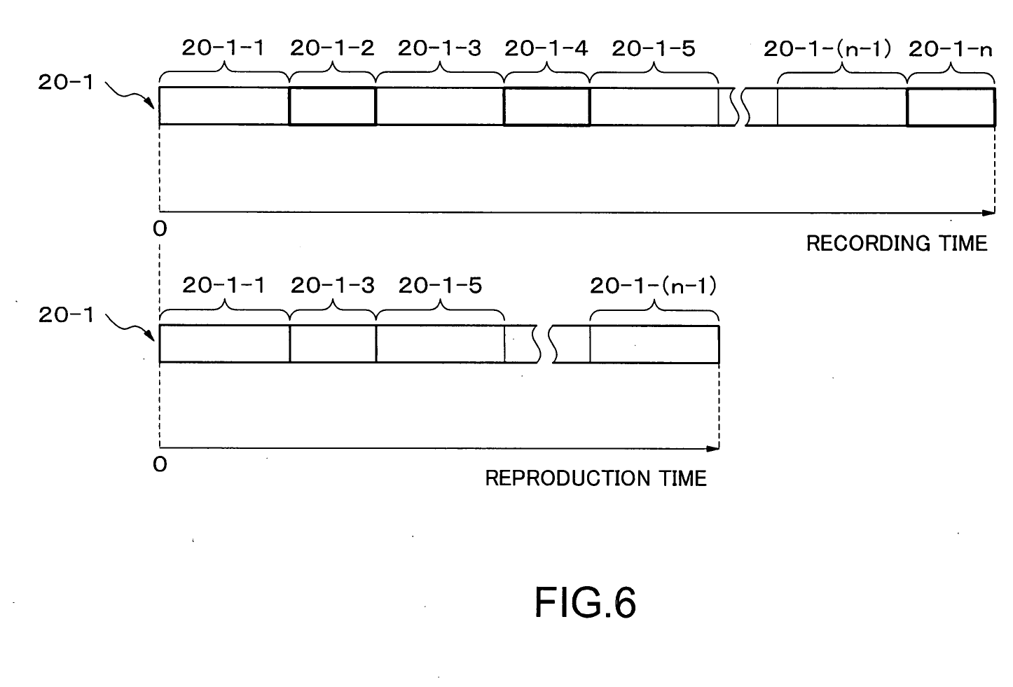

As shown in FIG. 6, the reproduction time for reproducing the moving image data 20-1-1, 20-1-3, 20-1-5, . . . , 20-1-(n−1) other than the undesired moving image data is shorter than the reproduction time (recording time) for reproducing and displaying all the edited moving image data 20-1 (moving image data 10-1). In this way, the moving image editing apparatus of the invention shortens the reproduction time.

Also, with the moving image editing apparatus of the invention, when the simple editing process or the high level editing process is performed, the editing time for editing each of the moving image data 10-1, 10-2, 10-3, 10-4 is shorter than the editing time for editing only the moving image data 10-1. In this way, with the moving image editing apparatus of the invention, the editing time is shortened into ¼. The detailed advantages in performing the simple editing process or the high level editing process will be described later.

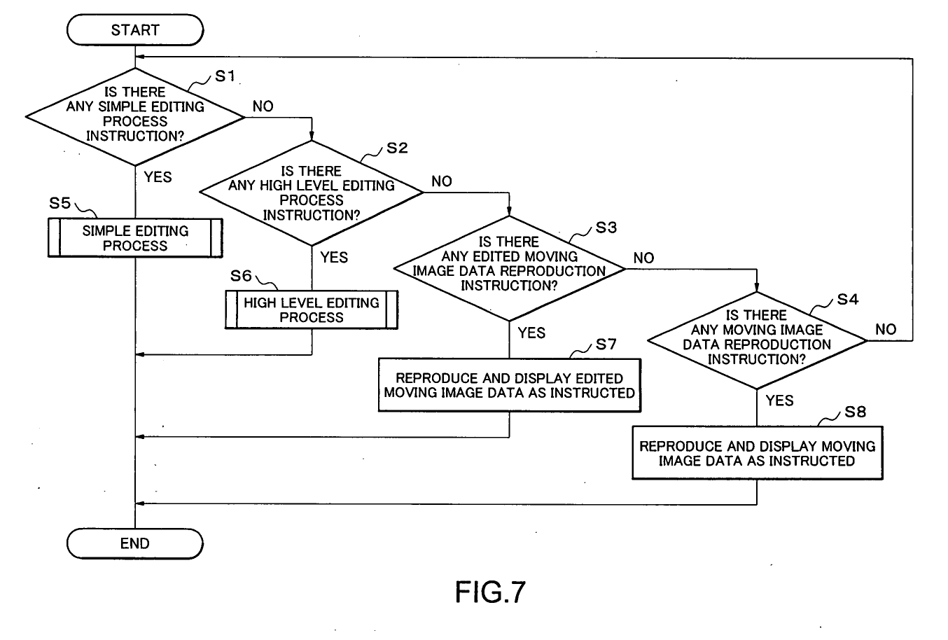

The operation (moving image editing method) of the moving image editing apparatus of the invention will be described below. FIG. 7 is a flowchart showing the operation of the moving image editing apparatus of the invention. Here, the precondition is the same as above. The operation of the moving image editing apparatus of the invention is involved in case (A) and case (B)

In the case of (A); the user unfamiliar with the computer edits “recorded program A”, “recorded program B”, “recorded program C”, and “recorded program D”, and views or listens to any one of the “recorded program A”, “recorded program B”, “recorded program C”, and “recorded program D”.

In the case of (B), the user familiar with the computer edits “recorded program A”, “recorded program B”, “recorded program C”, and “recorded program D”, and views or listens to any one of the “recorded program A”, “recorded program B”, “recorded program C”, and “recorded program D”.

Firstly, in the case of (A), the operation of the moving image editing apparatus of the invention will be described below.

The user issues a simple editing process instruction to the control unit 1, employing the operation unit 4 (YES at step S1 in FIG. 7). At this time, the operation screen display control part 14, the user specification control part 15 and the storage control part 16 of the control unit 1 perform a simple editing process in response to the simple editing process instruction of the user (step S5 in FIG. 7).

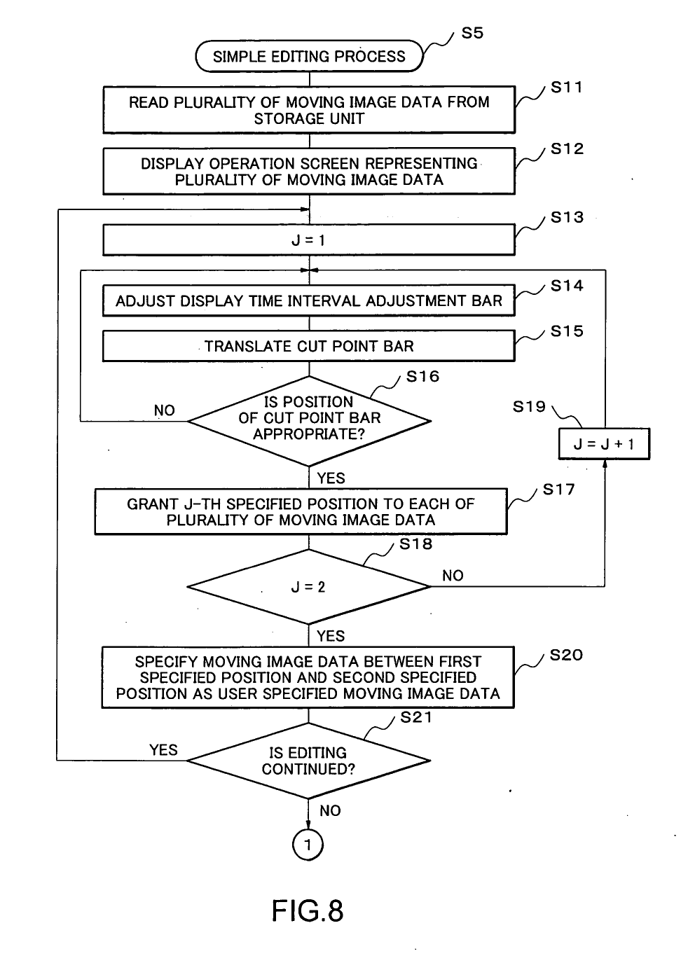

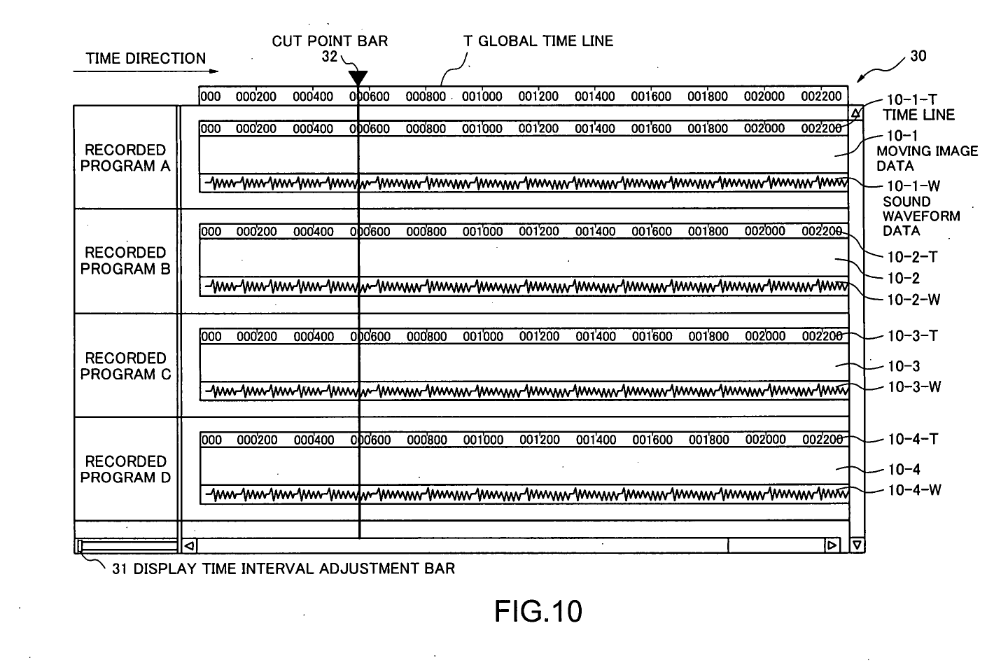

In the simple editing process (step S5), the user issues an image display instruction to the control unit 1, employing the operation unit 4. At this time, the operation screen display control part 14 reads the moving image data 10-1, 10-2, 10-3, 10-4 from the storage unit 3 (step S11 in FIG. 8) and displays an operation screen 30 as shown in FIG. 10 on the display unit 2 (step S12 in FIG. 8) in response to the image display instruction of the user. The operation screen 30 includes the program names “recorded program A”, “recorded program B”, “recorded program C” and “recorded program D”, the moving image data 10-1, 10-2, 10-3, 10-4, the time lines representing the time axis 10-1-T, 10-2-T, 10-3-T, 10-4-T, sound waveform data representing the sound in waveform 10-1-W, 10-2-W, 10-3-W, 10-4-W, global time line T, a display time interval adjustment bar 31, and a cut point bar 32.

At step S12, the operation screen display control part 14 displays the program names “recorded program A”, “recorded program B”, “recorded program C” and “recorded program D” on the operation screen 30. Also, the operation screen display control part 14 displays, on the operation screen 30, each of the moving image data 10-1, 10-2, 10-3, 10-4 read at step S11 in one direction, corresponding to the program names “recorded program A”, “recorded program B”, “recorded program C” and “recorded program D” displayed on the operation screen 30. Also, the operation screen display control part 14 displays the time lines 10-1-T, 10-2-T, 10-3-T, 10-4-T in one direction on the operation screen 30, corresponding to the moving image data 10-1, 10-2, 10-3, 10-4 displayed on the operation screen 30, in order to display the moving image data 10-1, 10-2, 10-3, 10-4 in time series.

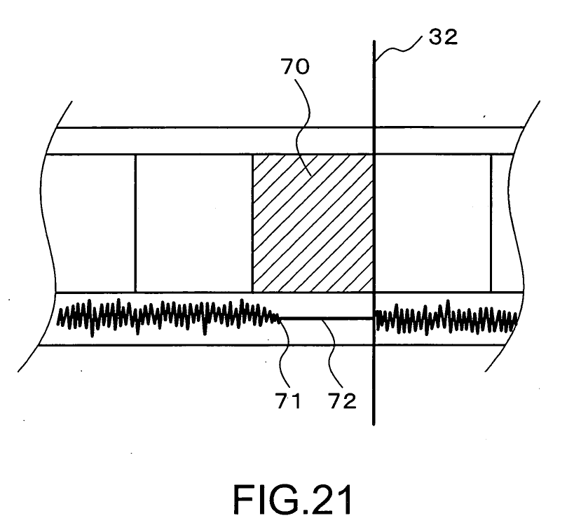

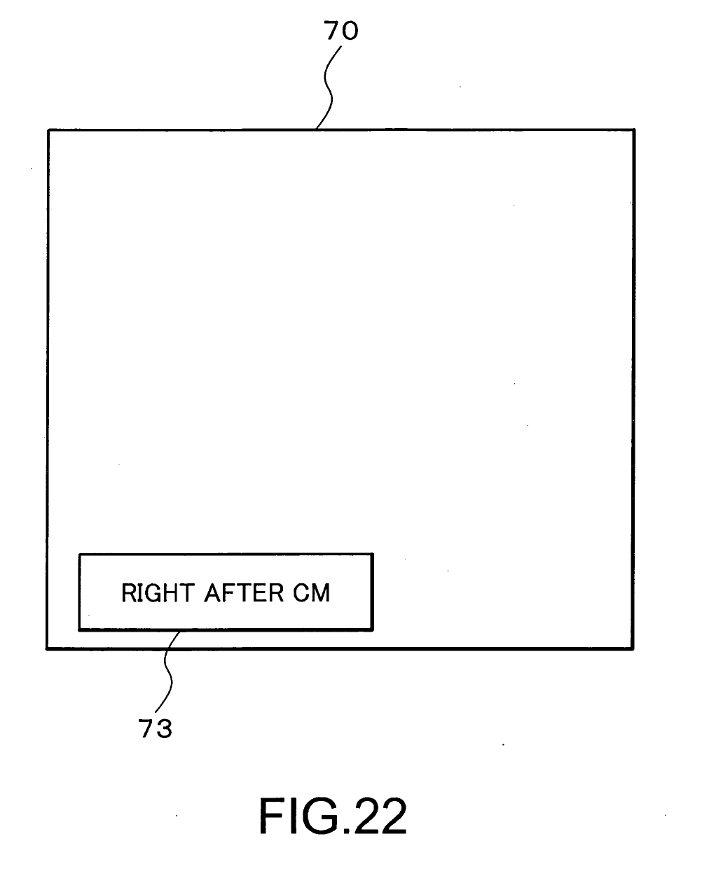

Thereby, the user can examine a plurality of frames of image data included in the moving image data 10-1, 10-2, 10-3, 10-4 displayed on the operation screen 30 at a time, and recognize the location of undesired moving image data within the “recorded program A”, “recorded program B”, “recorded program C” and “recorded program D” by referring to the plurality of frames of image data. In recognizing the location of undesired moving image data, the user can recognize the location of the boundary between the desired moving image data and the undesired moving image data of “recorded program A”, “recorded program B”, “recorded program C” and “recorded program D”, if a keyword 73 indicating transition to the undesired moving image data is reflected in the object frame of image data 70 among the plurality of frames of image data of the moving image data 10-1, 10-2, 10-3, 10-4 (see FIGS. 21 and 22). This keyword 73 is inserted or marked to the frame of image data beforehand.

Also, at step S12, the operation screen display control part 14 displays the sound waveform data 10-1-W, 10-2-W, 10-3-W, 10-4-W in one direction on the operation screen 30, corresponding to the moving image data 10-1, 10-2, 10-3, 10-4 displayed on the operation screen 30.

Thereby, the user can examine the sound wave form data 10-1-W, 10-2-W, 10-3-W, 10-4-W displayed on the operation screen 30 at a time, and recognize the location of the boundary between the desired moving image data and the undesired moving image data within the “recorded program A”, “recorded program B”, “recorded program C” and “recorded program D” by referring to the sound waveform data. For example, when the sound waveform data corresponding to the object frame of image data 70 among the plurality of frames of image data in the moving image data 10-1, 10-2, 10-3, 10-4 is a waveform 72 representing the silence, or a waveform 71 representing the fade out transitioning to the silence (see FIG. 21), the user can recognize the location of the boundary between the desired moving image data and the undesired moving image data of “recorded program A”, “recorded program B”, “recorded program C” and “recorded program D”.

Also, at step S12, the operation screen display control part 14 displays the global time line T representing the time in one direction on the operation screen 30, corresponding to each of the moving image data 10-1, 10-2, 10-3, 10-4 displayed on the operation screen 30. Thereby, the user can recognize visually a deviation between the time indicated by the time lines 10-1-T, 10-2-T, 10-3-T, 10-4-T displayed on the operation screen 30 and the time indicated by the global time line T displayed on the operation screen 30.

Also, at step S12, the operation screen display control part 14 displays the display time interval adjustment bar 31 on the operation screen 30, and displays, on the operation screen 30, the cut point bar 32 vertically for each of the moving image data 10-1, 10-2, 10-3, 10-4 displayed on the operation screen 30. The user can specify the location of the boundary between the desired moving image data and the undesired moving image data of the “recorded program A”, “recorded program B”, “recorded program C” and “recorded program D” by specifying the cut point bar 32 at each position of the moving image data 10-1, 10-2, 10-3, 10-4 displayed on the operation screen 30.

The user specification control part 15 of the control unit 1 sets variable J to 1 (step S13 in FIG. 8). The user issues an adjustment instruction, employing the operation unit 4, when the candidate moving image data 20-1-2, 20-2-2, 20-3-2, 20-4-2 among the moving image data 10-1, 10-2, 10-3, 10-4 are specified as the undesired moving image data.

First of all, the user issues an enlargement/contraction display instruction as the adjustment instruction by operating the display time interval adjustment bar 31, employing the operation unit 4. At this time, the user specification control part 15 displays in enlargement or contraction the moving image data 10-1, 10-2, 10-3, 10-4 with reference to the cut point bar 32 (step S14 in FIG. 8). The cut point bar 32 is used to determine the boundary between desired and undesired moving image data 10-1, 10-2, 10-3, 10-4.

For example, the user issues an enlargement/contraction display instruction by operating the display time interval adjustment bar 31, employing the operation unit 4, in order to refer to the location of the boundary between the desired moving image data and the undesired moving image data of the “recorded program A”, “recorded program B”, “recorded program C” and “recorded program D”.

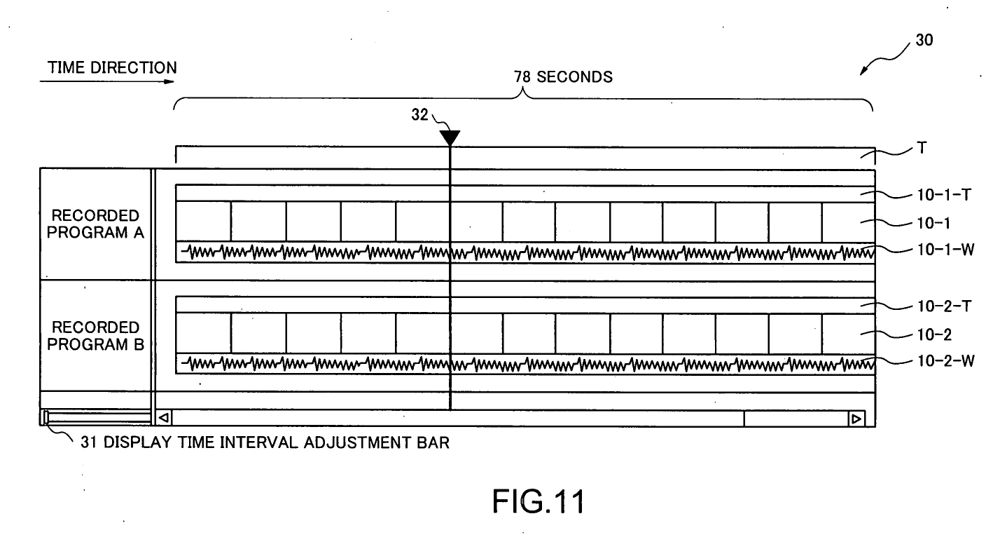

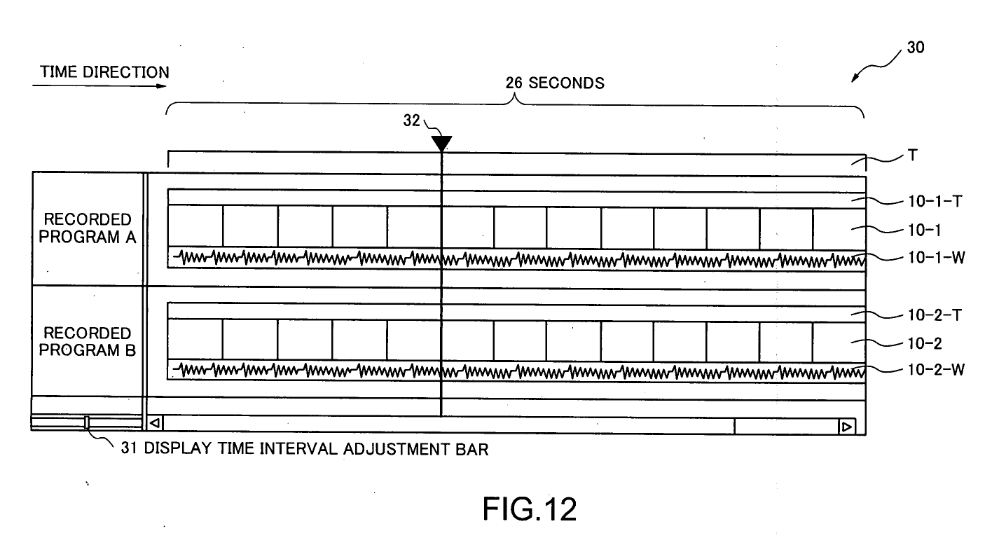

At this time, the user specification control part 15 displays in enlargement the moving image data 10-1, 10-2, 10-3, 10-4 with reference to the cut point bar 32. Herein, when a triple enlargement display instruction is issued by the display time interval adjustment bar 31, while the frame of image data included in the moving image data 10-1, 10-2 is displayed on the operation screen 30 for 78 seconds, the frames of image data of 26 seconds with reference to the cut point bar 32 is displayed in enlargement among the frames of image data of 78 seconds (see FIGS. 11 and 12).

The user operates the cut point bar 32 for the adjustment instruction, employing the operation unit 4. At this time, the user specification control part 15 specifies the cut point bar 32 at each position of the moving image data 10-1, 10-2, 10-3, 10-4 displayed on the operation screen 30 by moving the cut point bar 32 on the operation screen 30 in accordance with a user's operation of the cut point bar 32 (step S15 in FIG. 8). The user visually sees the cut point bar 32 on the operation screen 30, and make an operation for enabling the control unit 1 to perform steps S14, S15, employing the operation unit 4, if the position of the cut point bar 32 on the operation screen 30 is judged to be inappropriate (NO at step S16 in FIG. 8). The user visually sees the cut point bar 32 on the operation screen 30, and issues a first specified position adjustment instruction as the adjustment instruction, employing the operation unit 4, if the position of the cut point bar 32 on the operation screen 30 is judged to be appropriate (YES at step S16 in FIG. 8).

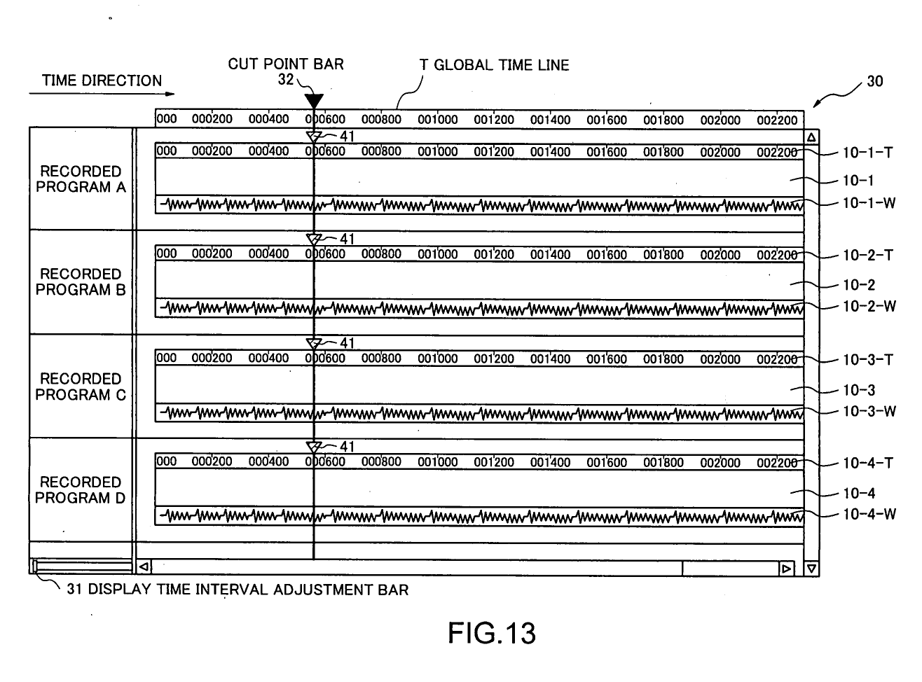

At this time, the user specification control part 15 labels the specified position of the cut point bar 32 as a first specified position 41 to each of the moving image data 10-1, 10-2, 10-3, 10-4 displayed on the operation screen 30 in response to the first specified position adjustment instruction of the user (step S1 in FIG. 8), as shown in FIG. 13. That is, the first specified position 41 indicates the time when the cut point bar 32 is specified on each of the time lines 10-1-T, 10-2-T, 10-3-T, 10-4-T displayed on the operation screen 30.

Then, the user specification control part 15 sets variable J to 2 (NO at step S18 and step S19 in FIG. 8). The user issues a second specified position adjustment instruction as the adjustment instruction, employing the operation unit 4, if the position of the cut point bar 32 on the operation screen 30 is judged to be appropriate (YES at step S16 in FIG. 8), as a result of making the operation for enabling the control unit 1 to perform the steps S14 to S16, employing the operation unit 4. The position of the cut point bar 32 is appropriate when the user visually sees that the cut point bar 32 is aligned on the boundary between a frame of image data 70 representing the desired moving image data and a frame of image data representing the undesired moving image data displayed on the operation screen 30.

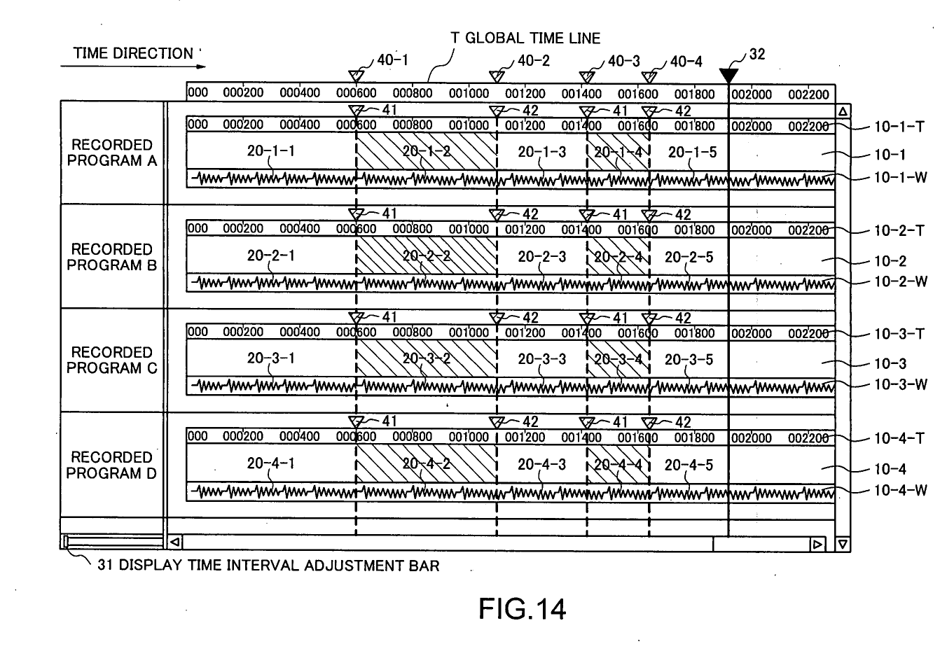

At this time, the user specification control part 15 grants the specified position of the cut point bar 32 as a second specified position 42 to each of the moving image data 10-1, 10-2, 10-3, 10-4 displayed on the operation screen 30 in response to the second specified position adjustment instruction of the user (step S17 in FIG. 8), as shown in FIG. 14. That is, the second specified position 42 indicates the time when the cut point bar 32 is specified on each of the time lines 10-1-T, 10-2-T, 10-3-T, 10-4-T displayed on the operation screen 30.

As shown in FIG. 14, the user specification control part 15 specifies the candidate moving image data 20-1-2, 20-2-2, 20-3-2, 20-4-2 that are moving image data between the first specified position 41 and the second specified position 42 as the undesired moving image data for the moving image data 10-1, 10-2, 10-3, 10-4 displayed on the operation screen 30, based on the first specified position 41 and the second specified position 42 (YES at step S18 and step S20 in FIG. 8). In this way, the undesired moving image data 20-1-2, 20-2-2, 20-3-2, 20-4-2 are related to each other with the above process.

Then, the user specification control part 15 displays a preview screen (not shown) representing the moving image data other than the undesired moving image data among the moving image data 10-1, 10-2, 10-3, 10-4 displayed on the operation screen 30. If the user continues editing by referring to the preview screen, or continues editing again because of being not satisfied with the preview result (YES at step S21 in FIG. 8), the user makes an operation for enabling the control unit 1 to perform the steps S13 to S21, employing the operation unit 4. By being satisfied with the preview result, the above related moving image data are confirmed to be the undesired moving image data altogether.

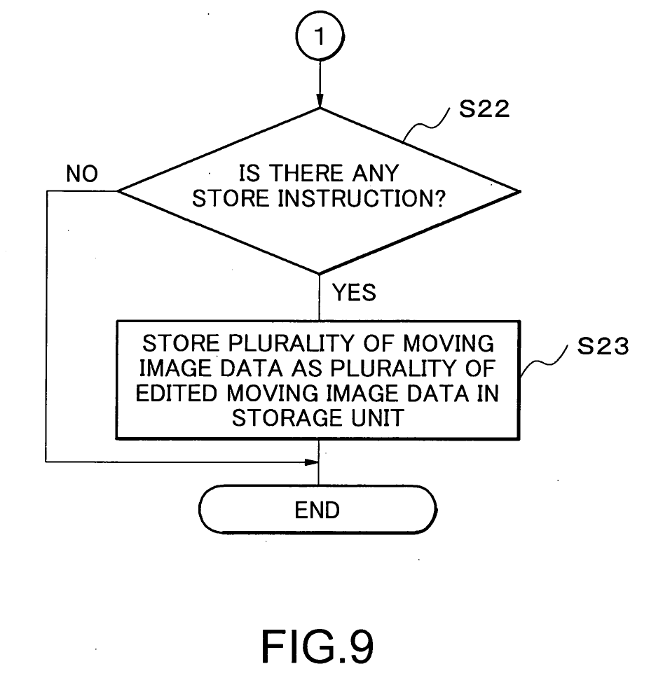

Thereafter, if it is determined that the editing of the “recorded program A”, “recorded program B”, “recorded program C” and “recorded program D” is completed (NO at step S21 in FIG. 8), the user issues a store instruction to the control unit 1, employing the operation unit 4 (YES at step S22 in FIG. 9). At this time, the storage control part 16 of the control unit 1 stores the moving image data 10-1, 10-2, 10-3, 1-0-4 with the undesired moving image data specified as the edited moving image data 20-1, 20-2, 20-3, 20-4 in the storage unit 3 in response to the store instruction of the user.

At this time, the edited result moving image data 80-1, 80-2, 80-3, 80-4 other than the undesired moving image data are stored as the reproduction moving image data of the edited moving image data 20-1, 20-2, 20-3, 20-4 in the storage unit 3 (step S23 in FIG. 9).

At step S23 here, the edited moving image data 20-1 includes the moving image data 10-1 already stored in the storage unit 3, and the information of undesired moving image data representing the undesired moving image data 20-1-2, 20-1-4, . . . specified in the moving image data 10-1, and the information of undesired moving image data includes the first specified position 41 and the second specified position 42. The edited moving image data 20-2 includes the moving image data 10-2 already stored in the storage unit 3, and the information of undesired moving image data representing the undesired moving image data 20-2-2, 20-2-4, . . . specified in the moving image data 10-2, and the information of undesired moving image data includes the first specified position 41 and the second specified position 42. The edited moving image data 20-3 includes the moving image data 10-3 already stored in the storage unit 3, and the information of undesired moving image data representing the undesired moving image data 20-3-2, 20-3-4, . . . specified in the moving image data 10-3, and the information of undesired moving image data includes the first specified position 41 and the second specified position 42. The edited moving image data 20-4 includes the moving image data 10-4 already stored in the storage unit 3, and the information of undesired moving image data representing the undesired moving image data 20-4-2, 20-4-4, . . . specified in the moving image data 10-4, and the information of undesired moving image data includes the first specified position 41 and the second specified position 42.

When the user specification control part 15 specifies the candidate moving image data 20-1-2, 20-2-2, 20-3-2, 20-4-2 as the undesired moving image at step S20, it displays the specified history positions 40-1, 40-2 on the global time line T on the operation screen 30, corresponding to the first specified position 41 and the second specified position 42. Also, when the user specification control part 15 specifies the candidate moving image data 20-1-4, 20-2-4, 20-3-4, 20-4-4, it displays the specified history positions 40-3, 40-4 on the global time line T on the operation screen 30, corresponding to the first specified position 41 and the second specified position 42. At step S23, the storage control part 16 stores the specified history positions 40-1, 40-2, 40-3, 40-4 in the storage unit 3. Thereby, when the user enables the control unit 1 to perform the simple editing process (step S5) again, the control unit 1 can support the movement of the cut point bar 32 at step S15. In this case, the operation screen display control part 14 reads the specified history positions 40-1, 40-2, 40-3, 40-4 stored in the storage unit 3 at step S11, and displays the specified history positions 40-1, 40-2, 40-3, 40-4 on the global time line T on the operation screen 30 at step S12.

Also, when the undesired moving image data is erroneously specified, namely, when the first specified position 41 and the second specified position 42 are erroneously specified at step S13 to S21, the user makes an operation for enabling the control unit 1 to perform the steps S13 to S21, employing the operation unit 4, thereby correcting the error.

Also, even when the edited moving image data 20-1 is stored in the storage unit 3 while the undesired moving image data is erroneously specified (the first specified position 41 and the second specified position 42 are erroneously specified) in the simple editing process (step S5), the error is corrected. Since the moving image data 10-1 is stored in the storage unit 3, the user may delete the erroneous edited moving image data 20-1 from the storage unit 3, employing the operation unit 4, and make an operation for enabling the control unit 1 to perform the simple editing process (step S5).

When the user wants to view or listen to the “recorded program A” without undesired moving image data after the simple editing process (step S5) is performed, the user issues a first edited moving image data reproduction instruction to the control unit 1, employing the operation unit 4 (NO at step S1, NO at step S2 and YES at step S3 in FIG. 7). At this time, the reproduction display control part 17 of the control unit 1 selects the edited moving image data 20-1 stored in the storage unit 3, in response to the first edited moving image data reproduction instruction of the user, and reproduces and displays the edited result moving image data 80-1 as the reproduction moving image data for the edited moving image data 20-1 on the display unit 2.

That is, the reproduction display control part 17 reproduces and displays the odd-numbered candidate moving image data 20-1-1, 20-1-3, 20-1-5, . . . , 20-1-(n−1) among the candidate moving image data 20-1-1 to 20-1-n of the edited moving image data 20-1 on the display unit 2 in accordance with the information of undesired moving image data included in the edited moving image data 20-1 (step S7 in FIG. 7).

On the other hand, when the user wants to view or listen to the “recorded program A” with undesired moving image data, the reproduction display control part 17 reproduces and displays the moving image data 10-1 stored in the storage unit 3 on the display unit 2 in response to the first moving image data reproduction instruction of the user (NO at step S1, NO at step S2, NO at step S3 and YES at step S4 in FIG. 7).

In the moving image editing apparatus of the invention, when the simple editing process (step S5) is performed, the reproduction time for reproducing and displaying the odd-numbered candidate moving image data 20-1-1, 20-1-3, 20-1-5, . . . , 20-1-(n−1) of the edited moving image data 20-1 is shorter than the reproduction time for reproducing and displaying all the moving image data 10-1. In this way, the moving image editing apparatus of the invention shortens the reproduction time.

Also, with the moving image editing apparatus of the invention, the simple editing process (step S5) is optimal when the user unfamiliar with the computer edits each of the moving image data 10-1, 10-2, 10-3, . . . , 10-m, as described above. In editing each of the moving image data 10-1, 10-2, 10-3, . . . , 10-m, the user may specify the undesired moving image data for each of the moving image data 10-1, 10-2, 10-3, . . . , 10-m displayed on the operation screen 30 in (n/2) times by issuing the adjustment instruction with reference to the operation screen 30.

In this case, the editing time for editing each of the moving image data 10-1, 10-2, 10-3, . . . , 10-m through the simple editing process (step S5) in (n/2) times is shorter than the editing time for editing only the moving image data 10-1 in (n/2) times. That is, the editing time for editing each of the moving image data 10-1, 10-2, 10-3, . . . , 10-m is shortened into 1/m. In this way, with the moving image editing apparatus of the invention, the editing time is shortened through the simple editing process (step S5).

The high level editing operation of the moving image editing apparatus of the invention in the case of (B) (e.g., high level editing) will be described below.

The user issues a high level editing process instruction to the control unit 1, employing the operation unit 4 (NO at step S1 and YES at step S2 in FIG. 7). At this time, the operation screen display control part 14, the user specification control part 15 and the storage control part 16 of the control unit 1 perform a high level editing process in response to the high level editing process instruction of the user (step S6 in FIG. 7).

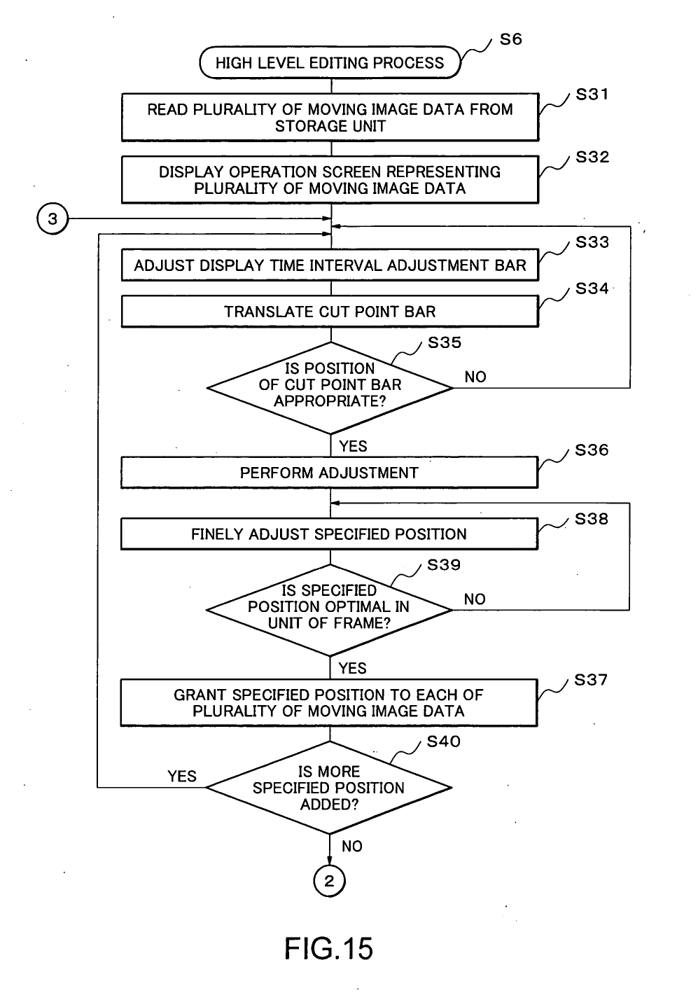

In the high level editing process (step S6), the user issues an image display instruction to the control unit 1, employing the operation unit 4. At this time, the operation screen display control part 14 reads the moving image data 10-1, 10-2, 10-3, 10-4 from the storage unit 3 (step S31 in FIG. 15) and displays the operation screen 30 as shown in FIG. 10 on the display unit 2 (step S32 in FIG. 15) in response to the image display instruction of the user. Herein, the steps S31, S32 are the same processing as the steps S11, S12 in FIG. 8.

In sorting the candidate moving image data 20-1-1, 20-2-1, 20-3-1, 20-4-1 among the moving image data 10-1, 10-2, 10-3, 10-4, the user issues a sorting adjustment instruction as the adjustment instruction, employing the operation unit 4.

First of all, the user issues an enlargement/contraction display instruction as the sorting adjustment instruction by operating the display time interval adjustment bar 31, employing the operation unit 4. At this time, the user specification control part 15 displays, in enlargement or contraction, the moving image data 10-1, 10-2, 10-3, 10-4 with reference to the cut point bar 32 (step S33 in FIG. 15). Herein, the step S33 is the same processing as the step S14 in FIG. 8 (see FIGS. 11, 12).

The user operates the cut point bar 32 to issue the sorting adjustment instruction, employing the operation unit 4. At this time, the user specification control part 15 moves the cut point bar 32 on the operation screen 30 to specify the cut point bar 32 at each position of the moving image data 10-1, 10-2, 10-3, 10-4 displayed on the operation screen 30 in accordance with the user's operation on the cut point bar 32 (step S34 in FIG. 15). Herein, the step S34 is the same processing as the step S15 in FIG. 8. The user visually sees the cut point bar 32 on the operation screen 30, and performs an operation for enabling the control unit 1 to perform steps S33, S34, employing the operation unit 4, if the position of the cut point bar 32 on the operation screen 30 is judged to be inappropriate (NO at step S35 in FIG. 15). For example, “in appropriate” may mean that the position of the cut point bar 32 is not aligned on the boundary between a frame of image data 70 representing the desired moving image data and a frame of image data representing the undesired moving image data displayed on the operation screen 30. The user visually sees the cut point bar 32 on the operation screen 30, and issues an adjustment execution instruction as the sorting adjustment instruction, employing the operation unit 4, if the position of the cut point bar 32 on the operation screen 30 is judged to be appropriate (YES at step S35 in FIG. 15). For example, “appropriate” may mean that the position of the cut point bar 32 is aligned on the boundary between a frame of image data 70 representing the desired moving image data and a frame of image data representing the undesired moving image data displayed on the operation screen 30. At this time, the user specification control part 15 an adjustment process in response to the adjustment execution instruction of the user (step S36).

In the adjustment process (step S36), the user specification control part 15 specifies the cut point bar 32 at each position of the moving image data 10-1, 10-2, 10-3, 10-4 displayed on the operation screen 30. For example, when the “program A”, “program B”, “program C” and “program D” broadcast at the same slot are recorded as the “recorded program A”, “recorded program B”, “recorded program C” and “recorded program D”, the recording start time may be varied. In this case, the position of the undesired moving image data broadcast within the “recorded program A”, “recorded program B”, “recorded program C” and “recorded program D” may be deviated.

Therefore, the user specification control part 15 detects a scene of the boundary between a frame of image data 70 (see FIG. 21) representing the desired moving image data and a frame of image data representing the undesired moving image data for each of the moving image data 10-1, 10-2, 10-3, 10-4 displayed on the operation screen 30. The methods of scene detection include sound change detection, silence part detection, sound change part detection or screen change detection.

In the sound change detection, the frame of image data is detected when the sound represented by the corresponding sound waveform data is changed from stereo to monaural sound among a plurality of frames of image data for the moving image data 10-1, 10-2, 10-3, 10-4. Also, the frame of image data is detected when the sound represented by the corresponding sound waveform data is changed from monaural to stereo sound among a plurality of frames of image data for the moving image data 10-1, 10-2, 10-3, 10-4.

In the silence part detection, the frame of image data 70 corresponding to the sound waveform data that is the waveform 72 representing the silence is detected among a plurality of frames of image data for the moving image data 10-1, 10-2, 10-3, 10-4 (see FIG. 21).

In the sound change part detection, the frame of image data 70 corresponding to the sound waveform data that is the waveform 71 representing the fade out is detected among a plurality of frames of image data for the moving image data 10-1, 10-2, 10-3, 10-4 (see FIG. 21).

In the screen change detection, the frame of image data 70 reflecting the keyword 73 indicating transition to the undesired moving image data is detected among a plurality of frames of image data for the moving image data 10-1, 10-2, 10-3, 10-4 (see FIG. 22). This keyword 73 is inserted or marked to the frame of image data beforehand.

With regard to the screen change detection, there are other examples as shown below. The screen change may be detected when the screen is faded out and the frame of image data 70 becomes monotone. The screen change may also be detected by monitoring the specific position inside the screen. For example, before starting the commercial, tickers like “After commercial, . . . ” may be displayed in the lower part of the screen. By detecting such tickers, the boundary between the main program and the commercial is recognized.

The screen change detection may also be achieved by numerically converting the characteristics of the frame of image data 70. For example, the frame of image data 70 corresponding to the rapid motion has a high value. When the difference between the values of those frames of image data 70 exceeds some threshold, the scene is regarded as changed.

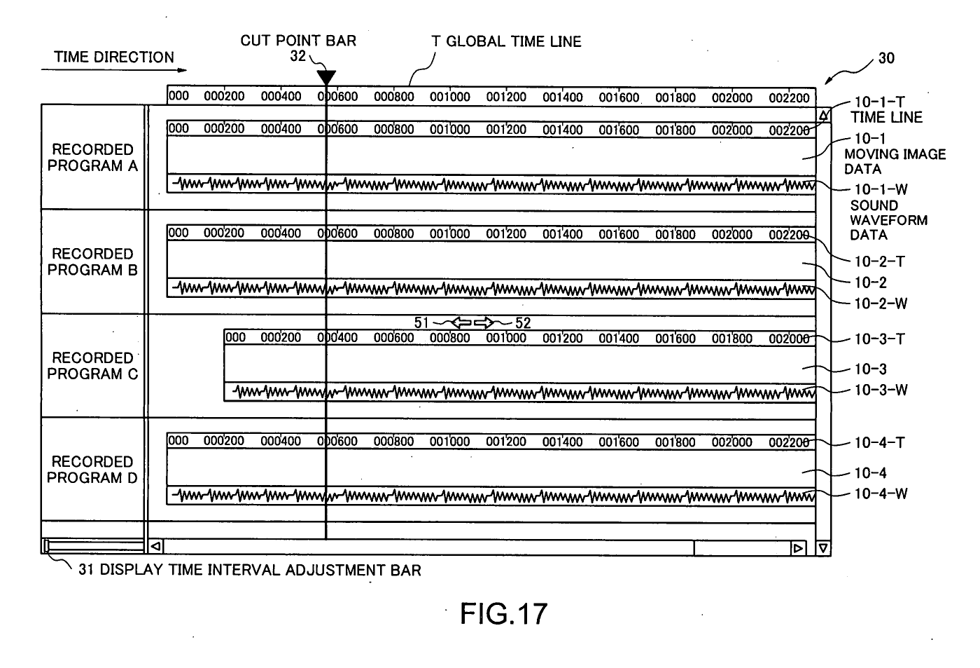

As shown in FIG. 17, the user specification control part 15 moves each of the moving image data 10-1, 10-2, 10-3, 10-4 displayed on the operation screen 30 so as to specify the cut point bar 32 at the boundary between a frame of image data 70 (see FIG. 21) representing the desired moving image data and a frame of image data representing the undesired moving image data for each of the moving image data 10-1, 10-2, 10-3, 10-4 displayed on the operation screen 30. The result of the above scene detection guides this specification of the cut point bar 32. The scenes are not necessarily detected in all moving image data 10-1, 10-2, 10-3, and 10-4, but the scenes detected in some of the moving image data 10-1, 10-2, 10-3, and 10-4 may be utilized when those scenes show a typical trend of the scene changes.

Herein, the user specification control part 15 translates the moving image data 10-3 displayed on the operation screen 30 in parallel to a first direction 51 parallel to the moving image data 10-3, or a second direction 52 opposite to the first direction 51. In FIG. 17, a state after translation in the second direction 52 is shown.

Then, the user issues the sorting adjustment instruction, employing the operation unit 4. The scene detection at step S36 may be invalid. In this case, the user detects the scene by visually seeing the boundary between the frames of image data representing the desired moving image data and the frames of image data representing the undesired moving image data for each of the moving image data 10-1, 10-2, 10-3, 10-4 displayed on the operation screen 30. The user translates each of the moving image data 10-1, 10-2, 10-3, 10-4 displayed on the operation screen 30 so as to specify the cut point bar 32 at the boundary, employing the operation screen 30. In this way, the user makes the fine adjustment for each specified position of the moving image data 10-1, 10-2, 10-3, 10-4 displayed on the operation screen 30 (step S38 in FIG. 15).

Thereafter, the user visually sees each specified position of the moving image data 10-1, 10-2, 10-3, 10-4 displayed on the operation screen 30, and enables the control unit 1 to perform step S38, employing the operation unit 4, if it is determined that the specified position is inappropriate in a unit of frame (NO at step S39 in FIG. 15).

The user visually sees each specified position of the moving image data 10-1, 10-2, 10-3, 10-4 displayed on the operation screen 30, and it is determined that each specified position 50 of the moving image data 10-1, 10-2, 10-3, 10-4 is appropriate in a unit of frame (YES at step S39 in FIG. 15). In this way, the undesired moving image data are related to each other with the above process.

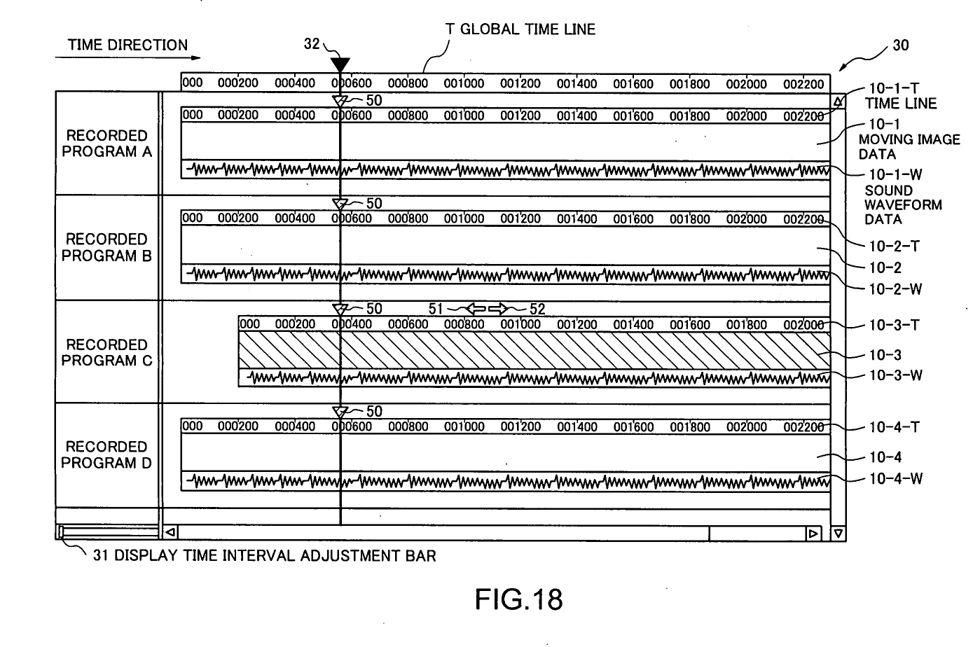

The user issues a specified position adjustment instruction as the sorting adjustment instruction, employing the operation unit 4. At this time, the user specification control part 15 grants the specified position of the cut point bar 32 as the specified position 50 to each of the moving image data 10-1, 10-2, 10-3, 10-4 displayed on the operation screen 30 in response to the specified position adjustment instruction of the user (step S37 in FIG. 15), as shown in FIG. 18. That is, the specified position 50 indicates the time when the cut point bar 32 is specified for each of the time lines 10-1-T, 10-2-T, 10-3-T, 10-4-T displayed on the operation screen 30.

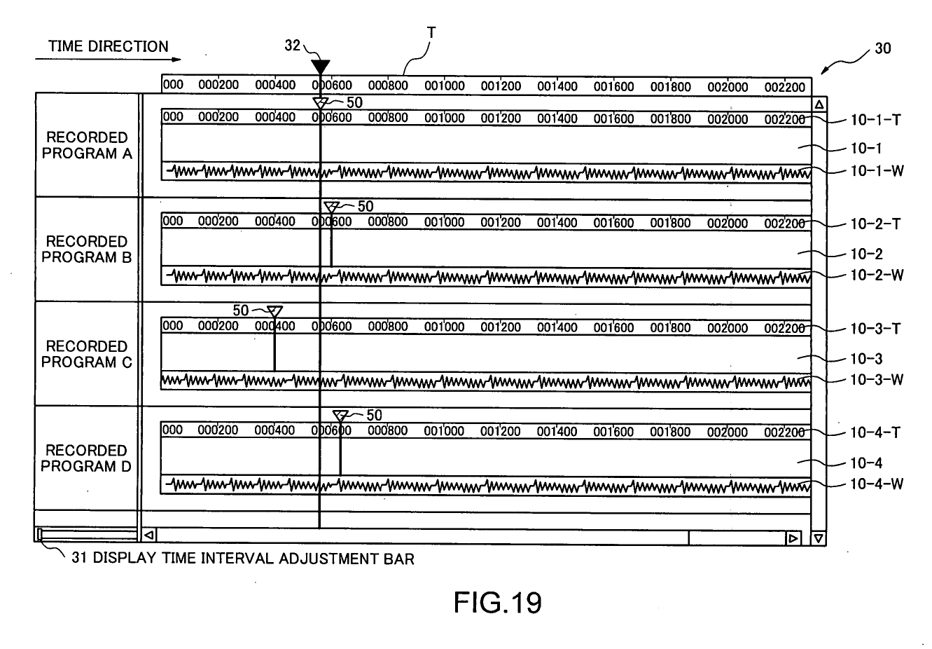

Herein, the user can translate (align) each of the moving image data 10-1, 10-2, 10-3, 10-4 displayed on the operation screen 30 in conformance to the global time line T, employing the operation unit 4, as needed (see FIG. 19).

In this case, the user specification control part 15 translated the moving image data 10-1, 10-2, 10-3, 10-4 in parallel to the first direction 51 or the second direction 52 in accordance with a user's operation of the operation unit 4. In FIG. 19, a state after translating the moving image data 10-3 in parallel to the second direction 52 is shown.

Thereafter, in sorting the candidate moving image data 20-1-2, 20-2-2, 20-3-2, 20-4-2 among the moving image data 10-1, 10-2, 10-3, 10-4 (YES at step S40 in FIG. 15) (NO at step S40 and NO at step S41 in FIG. 15), the user makes an operation for enabling the control unit 1 to perform the steps S33 to S40, employing the operation unit 4. Moreover, in sorting the candidate moving image data 20-1-3, 20-2-3, 20-3-3, 20-3-3, 20-4-3 among the moving image data 10-1, 10-2, 10-3, 10-4 (YES at step S40 in FIG. 15), the user makes an operation for enabling the control unit 1 to perform the steps S33 to S40, employing the operation unit 4. Moreover, in sorting the candidate moving image data 20-1-4, 20-2-4, 20-3-4, 20-4-4 among the moving image data 10-1, 10-2, 10-3, 10-4 (YES at step S40 in FIG. 15), the user makes an operation for enabling the control unit 1 to perform the steps S33 to S40, employing the operation unit 4. In the following, the operation is continued for the candidate moving image data in the same manner.

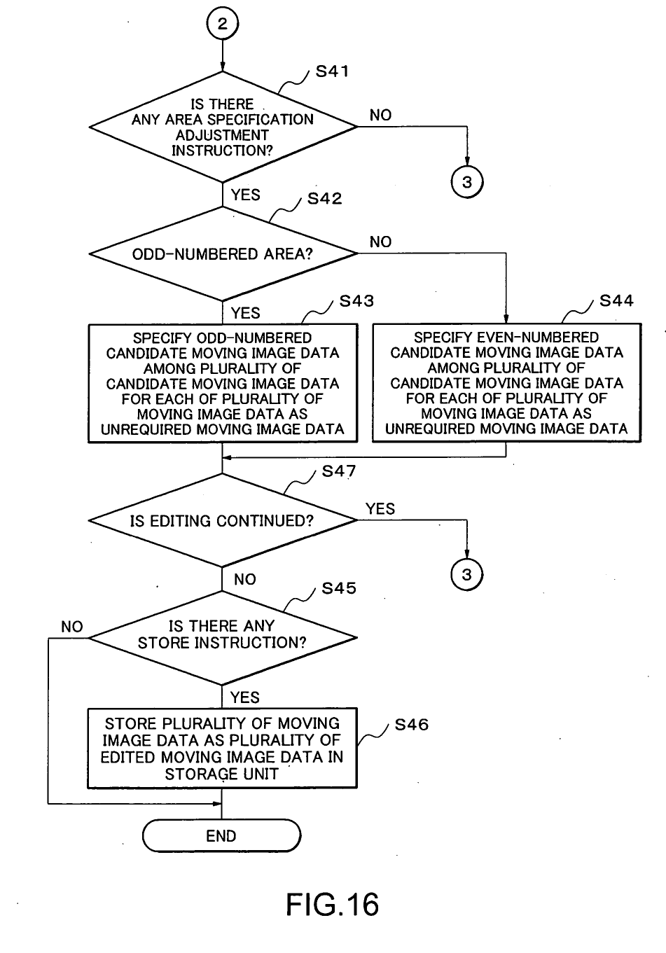

Then, if it is determined that the process of sorting the candidate moving image data 20-1-1 to 20-1-n, 20-2-1 to 20-2-n, 20-3-1 to 20-3-n, 20-4-1 to 20-4-n from the moving image data 10-1, 10-2, 10-3, 10-4 is completed (YES at step S41 in FIG. 16), the user issues an area specification adjustment instruction indicating the odd or even number to the control unit 1, employing the operation unit 4 (step S42 in FIG. 16). When the area specification adjustment instruction indicates the odd number (YES at step S42 in FIG. 16), the user specification control part 15 specifies the odd-numbered candidate moving image data among a plurality of candidate moving image data for each of the moving image data 10-1, 10-2, 10-3, 10-4 as the undesired moving image data (step S43 in FIG. 16). When the area specification adjustment instruction indicates the even number (NO at step S42 in FIG. 16), the user specification control part 15 specifies the even-numbered candidate moving image data among a plurality of candidate moving image data for each of the moving image data 10-1, 10-2, 10-3, 10-4 as the undesired moving image data (step S44 in FIG. 16). In this way, the above related moving image data are confirmed to be the undesired moving image data altogether.

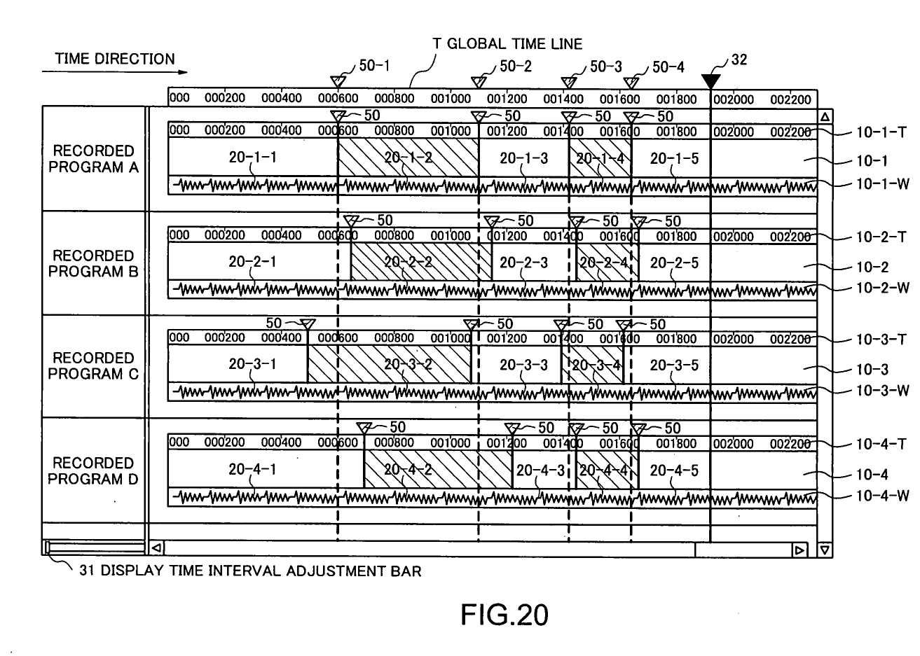

When the area specification adjustment instruction is the even number (NO at step S42 in FIG. 16), the user specification control part 15 specifies the candidate moving image data 20-1-2, 20-1-4, . . . , 20-1-n among the candidate moving image data 20-1-1 to 20-1-n of the moving image data 10-1 as the undesired moving image data, as shown in FIG. 20. The user specification control part 15 specifies the candidate moving image data 20-2-2, 20-2-4, . . . , 20-2-n among the candidate moving image data 20-2-1 to 20-2-n of the moving image data 10-2 as the undesired moving image data. The user specification control part 15 specifies the candidate moving image data 20-3-2, 20-3-4, . . . , 20-3-n among the candidate moving image data 20-3-1 to 20-3-n of the moving image data 10-3 as the undesired moving image data. The user specification control part 15 specifies the candidate moving images data 20-4-2, 20-4-4, . . . , 20-4-n among the candidate moving image data 20-4-1 to 20-4-n of the moving image data 10-4 as the undesired moving image data.

Then, the user specification control part 15 displays a preview screen (not shown) representing the moving image data other than the undesired moving image data among the moving image data 10-1, 10-2, 10-3, 10-4 displayed on the operation screen 30. If the user continues editing by referring to the preview screen, or continues editing again because of being unsatisfied with the preview result (YES at step S47 in FIG. 16), the user makes an operation for enabling the control unit 1 to perform the steps S33 to S44 and S47, employing the operation unit 4.

Thereafter, if it is determined that the editing of the “recorded program A”, “recorded program B”, “recorded program C” and “recorded program D” is completed (NO at step S47 in FIG. 16), the user issues a store instruction to the control unit 1, employing the operation unit 4 (YES at step S45 in FIG. 16). At this time, the storage control part 16 of the control unit 1 stores the moving image data 10-1, 10-2, 10-3, 10-4 with the undesired moving image data specified as the edited moving image data 20-1, 20-2, 20-3, 20-4 in the storage unit 3 in response to the store instruction of the user.

At this time, the edited result moving image data 80-1, 80-2, 80-3, 80-4 other than the undesired moving image data are stored as the reproduction moving image data of the edited moving image data 20-1, 20-2, 20-3, 20-4 in the storage unit 3 (step S46 in FIG. 16).

At step S46 here, the edited moving image data 20-1 includes the moving image data 10-1 already stored in the storage unit 3, and the information of undesired moving image data representing the undesired moving image data 20-1-2, 20-1-4, . . . 20-1-n specified in the moving image data 20-1-2, 20-1-4, . . . 20-1-n specified in the moving image data 10-1, and the information of undesired moving image data includes the specified position 50. The edited moving image data 20-2 includes the moving image data 10-2 already stored in the storage unit 3, and the information of undesired moving image data representing the undesired moving image data 20-2-2, 20-2-4, . . . , 20-2-n specified in the moving image data 10-2, and the information of undesired moving image data includes the specified position 50. The edited moving image data 20-3 includes the moving image data 10-3 already stored in the storage unit 3, and the information of undesired moving image data representing the undesired moving image data 20-3-2, 20-3-4, . . . , 20-3-n specified in the moving image data 10-3, and the information of undesired moving image data includes the specified position 50. The edited moving image data 20-4 includes the moving image data 10-4 already stored in the storage unit 3, and the information of undesired moving image data representing the undesired moving image data 20-4-2, 20-4-4, . . . , 20-4-n specified in the moving image data 10-4, and the information of undesired moving image data includes the specified position 50.

When the user specification control part 15 specifies the candidate moving image data 20-1-2, 20-2-2, 20-3-2, 20-4-2 as the undesired moving image at step S44, it displays the specified history positions 50-1, 50-2 corresponding to the specified positions 50, 50 on the global time line T on the operation screen 30.

Also, when the user specification control part 15 specifies the candidate moving image data 20-1-4, 20-2-4, 20-3-4, 20-4-4, it displays the specified history positions 50-3, 50-4 on the global time line T on the operation screen 30, corresponding to the specified positions 50, 50. At step S46, the storage control part 16 stores the specified history positions 50-1, 50-2, 50-3, 50-4 in the storage unit 3. 50-2, 50-3, 50-4 in the storage unit 3.

Thereby, when the user enables the control unit 1 to perform the high level editing process (step S6) again, the control unit 1 can support the movement of the cut point bar 32 at step S34. In this case, the operation screen display control part 14 reads the specified history positions 50-1, 50-2, 50-3, 50-4 stored in the storage unit 3 at step S31, and displays the specified history positions 50-1, 50-2, 50-3, 50-4 on the global time line T on the operation screen 30 at step S32.

Also, when the undesired moving image data is erroneously specified, namely, when the specified position 50 is erroneously specified at step S33 to S44, the user makes an operation for enabling the control unit 1 to perform the steps S33 to S44, employing the operation unit 4, thereby correcting the error.

Also, even when the edited moving image data 20-1 is stored in the storage unit 3 while the undesired moving image data is erroneously specified (the specified position 50 is erroneously specified) in the high level editing process (step S6), the error is corrected. Since the moving image data 10-1 is stored in the storage unit 3, the user may delete the erroneous edited moving image data 20-1 from the storage unit 3, employing the operation unit 4, and make an operation for enabling the control unit 1 to perform the high level editing process (step S6).

When the user wants to view or listen to the “recorded program A” without undesired moving image data after the high level editing process (step S6) is performed, the user issues a first edited moving image data reproduction instruction to the control unit 1, employing the operation unit 4 (NO at step S1, NO at step S2 and YES at step S3 in FIG. 7).

At this time, the reproduction display control part 17 of the control unit 1 selects the edited moving image data 20-1 stored in the storage unit 3, in response to the first edited moving image data reproduction instruction of the user, and reproduces and displays the edited result moving image data 80-1 as the reproduction moving image data for the edited moving image data 20-1 on the display unit 2.

That is, the reproduction display control part 17 reproduces and displays the odd-numbered candidate moving image data 20-1-1, 20-1-3, 20-1-5, . . . , 20-1-(n−1) among the candidate moving image data 20-1-1 to 20-1-n of the edited moving image data 20-1 on the display unit 2 in accordance with the information of undesired moving image data included in the edited moving image data 20-1 (step S7 in FIG. 7).

On the other hand, when the user wants to view or listen to the “recorded program A” with undesired moving image data, the reproduction display control part 17 reproduces and displays the moving image data 10-1 stored in the storage unit 3 on the display unit 2 in response to the first moving image data reproduction instruction of the user (NO at step S1, NO at step S2, NO at step S3 and YES at step S4 in FIG. 7).

In the moving image editing apparatus of the invention, when the high level editing process (step S6) is performed, the reproduction time for reproducing and displaying the odd-numbered candidate moving image data 20-1-1, 20-1-3, 20-1-5, . . . , 20-1-(n−1) of the edited moving image data 20-1 is shorter than the reproduction time for reproducing and displaying all the moving image data 10-1. In this way, the moving image editing apparatus of the invention shortens the reproduction time.

Also, with the moving image editing apparatus of the invention, the high level editing process (step S6) is optimal when the user familiar with the computer edits each of the moving the adjustment instruction, the user specifies the undesired moving image data for each of the moving image data 10-1, 10-2, 10-3, . . . , 10-m displayed on the operation screen 30 at a time. That is, in editing each of the moving image data 10-1, 10-2, 10-3, . . . , 10-m, the user sorts each of the moving image data 10-1, 10-2, 10-3, . . . , 10-m displayed on the operation screen 30 into a plurality of candidate moving image data by issuing a sorting adjustment instruction while referring to the operation screen 30.

Thereby, in issuing one sorting adjustment instruction while referring to the operation screen 30, the user can specify the undesired moving image data at a time for each of the moving image data 10-1, 10-2, 10-3, . . . , 10-m displayed on the operation screen 30. Herein, when the moving image data desired by the user is the odd-numbered candidate moving image data, and the moving image data undesired by the user is the even-number candidate moving data, the user may specify the even-numbered candidate moving image data as the undesired moving image data.

The editing time for editing each of the moving image data 10-1, 10-2, 10-3, . . . , 10-m through the high level editing process (step S6) in (n/2) times is shortened into 1/m the editing time for editing only the moving image data 10-1 in (n/2) times with the undesired moving image data specified and further editing each of the m moving image data. In this way, with the moving image editing apparatus of the invention, the editing time is shortened through the high level editing process (step S6).

Also, with the moving image editing apparatus of the invention, the cut point bar 32 is automatically set at each position of the moving image data 10-1, 10-2, 10-3, . . . , 10-m displayed on the operation screen 30 by performing the adjustment process in response to the sorting adjustment instruction of the user, whereby the editing time is further shortened.

In the above explanation, with the moving image editing apparatus of the invention, the editing time for editing the moving image data is shortened, and the reproduction time for reproducing and displaying the moving image data is shortened.

In the above explanation, this invention provides the following exemplary advantages.

With the moving image editing apparatus of the invention, the editing time for editing the moving image data is shortened, and the reproduction time for reproducing and displaying the moving image data is shortened.

Although the exemplary embodiments of the present invention have been described in detail, it should be understood that various changes, substitutions and alternatives can be made therein without departing from spirit and scope of the invention as defined by the appended claims.

Further, it is the inventor's intent to retain all equivalents of the claimed invention even if the claims are amended during prosecution.

What is claimed is:

1. A moving image editing apparatus including a display unit for displaying a plurality of moving image data, and a control unit, said moving image data being categorized into first and second moving image data, said control unit comprising:
an operation screen display control part that displays an operation screen representing said plurality of moving image data on said display unit; and
a user specification control part that specifies first moving image data for each of said plurality of moving image data displayed on said operation screen.

2. A moving image editing apparatus according to claim 1, wherein said user specification control part relates said first moving image data of said plurality of moving image data together, and specifies said first moving image data of said plurality of moving image data together.

3. A moving image editing apparatus according to claim 1, further comprising a storage unit that stores said plurality of moving image data,
wherein said control unit further comprises a storage control part that stores said plurality of moving image data with said first and said second moving image data specified as a plurality of edited moving image data in said storage unit.

4. A moving image editing apparatus according to claim 3, said control unit further comprising:
a reproduction display control part that selects the first edited moving image data among said plurality of edited moving image data stored in said storage unit and reproducing and displaying either said first moving image data or said second moving image data among said first edited moving image data.

5. The moving image editing apparatus according to claim 1, wherein said operation screen display control part displays each of said plurality of moving image data in one direction in a time series on said operation screen, and displays a cut point bar vertically on said operation screen for each of said plurality of moving image data displayed on said operation screen, and
wherein said user specification control part specifies said cut point bar at a first position and a second position for each of said plurality of moving image data displayed on said operation screen to represent said first position and said second position as a first specified position and a second specified position to each of said plurality of moving image data displayed on said operation screen, and specifies the moving image data between said first specified position and said second specified position as said first moving image data for each of said plurality of moving image data displayed on said operation screen, based on said first specified position and said second specified position.

6. The moving image editing apparatus according to claim 1, wherein said user specification control part is instructed with an adjustment instruction, and said adjustment instruction includes a sorting adjustment instruction and an area specification adjustment instruction, and
wherein said user specification control part sorts each of said plurality of moving image data displayed on said operation screen in to a plurality of candidate moving image data in response to said sorting adjustment instruction, and specifies one candidate moving image data of the odd-numbered candidate moving image data and the even-numbered candidate moving image data among said plurality of candidate moving image data for each of said plurality of moving image data displayed on said operation screen as said first moving image data in response to said area specification adjustment instruction.

7. The moving image editing apparatus according to claim 6, wherein said operation screen display control part displays each of said plurality of moving image data stored in said storage unit in one direction in a time series on said operation screen, and displays a cut point bar vertically on said operation screen for each of said plurality of moving image data displayed on said operation screen, and
wherein said user specification control part specifies said cut point bar at a plurality of positions for each of said plurality of moving image data displayed on said operation screen to represent said plurality of positions as a plurality of specified positions to each of said plurality of moving image data displayed on said operation screen in response to said sorting adjustment instruction, and sorts each of said plurality of moving image data displayed on said operation screen into said plurality of candidate moving image data, based on said plurality of specified positions.

8. The moving image editing apparatus according to claim 7, wherein said user specification control part performs an adjustment process for specifying said cut point bar at said plurality of positions for each of said plurality of moving image data displayed on said operation screen in response to said sorting adjustment instruction.

9. The moving image editing apparatus according to claim 1, wherein said first moving imaged at a comprises one of a commercial and an advertisement.

10. The moving image editing apparatus according to claim 3, wherein each of said plurality of moving image data comprises a recorded program periodically telecast in a same time slot.

11. A moving image editing method that is performed on a computer connected to a display unit for displaying a plurality of moving image data, said moving image data being categorized into first and second moving image data, said method comprising the steps of:
displaying an operation screen representing said plurality of moving image data stored in said storage unit on said display unit in response to an image display instruction; and
specifying the first moving image data for each of said plurality of moving image data displayed on said operation screen in response to an adjustment instruction.

12. A moving image editing method according to claim 11, wherein said specifying relates said first moving image data of said plurality of moving image data together, and specifies said first moving image data of said plurality of moving image data together.

13. A moving image editing method according to claim 11, wherein said method further comprising:
storing said plurality of moving image data with said first moving image data specified as a plurality of edited moving image data in said storage unit in response to a store instruction.

14. A moving image editing method according to claim 13, said method further comprising:
selecting the first edited moving image data among said plurality of edited moving image data stored in said storage unit and reproducing and displaying either said first moving image data or said second moving image data among said first edited moving image data in response to a first edited moving image data reproduction instruction.

15. The moving image editing method according to claim 11, wherein said method further comprises:
displaying each of said plurality of moving image data in one direction in a time series on said operation screen and displays a cut point bar vertically on said operation screen for each of said plurality of moving image data displayed on said operation screen in response to said image display instruction; and
said specifying further comprises specifying said cut point bar at a first position and a second position for each of said plurality of moving image data displayed on said operation screen to represent said first position and said second position as a first specified position and a second specified position to each of said plurality of moving image data displayed on said operation screen in response to said adjustment instruction, and specifying the moving image data between said first specified position and said second specified position as said first moving image data for each of said plurality of moving image data displayed on said operation screen, based on said first specified position and said second specified position.

16. The moving image editing method according to claim 11, wherein said specifying further comprises:
sorting each of said plurality of moving imaged at a displayed on said operation screen into a plurality of candidate moving image data in response to a sorting adjustment instruction included in said adjustment instruction; and
specifying one candidate moving image data of the odd-numbered candidate moving image data and the even-numbered candidate moving image data among said plurality of candidate moving image data for each of said plurality of moving image data displayed on said operation screen as said first moving image data in response to an area specification adjustment instruction included in said adjustment instruction.

17. The moving image editing method according to claim 16, wherein said displaying further comprises:
displaying each of said plurality of moving image data in one direction in a time series on said operation screen and displaying a cut point bar vertically on said operation screen for each of said plurality of moving image data displayed on said operation screen in response to said image display instruction, and
wherein said specifying further comprises:
specifying said cut point bar at a plurality of positions for each of said plurality of moving image data displayed on said operation screen to represent said plurality of positions as a plurality of specified positions to each of said plurality of moving image data displayed on said operation screen in response to said sorting adjustment instruction; and
sorting each of said plurality of moving image data displayed on said operation screen into said plurality of candidate moving image data, based on said plurality of specified positions.

18. The moving image editing method according to claim 17, wherein said specifying further comprises:
performing an adjustment process for specifying said cut point bar at said plurality of positions for each of said plurality of moving image data displayed on said operation screen in response to said sorting adjustment instruction.

19. The moving image editing method according to claim 11, wherein said first moving image data comprises one of a commercial and an advertisement.

20. The moving image editing method according to claim 13, wherein each of said plurality of moving image data is a recorded program periodically telecast in a same time slot.

21. A signal-bearing medium tangibly embodying a program of machine-readable instructions executable by a digital processing apparatus to perform the method of claim 11.

22. A moving image editing apparatus including a display unit for displaying a plurality of moving image data, and a control unit, said moving image data being categorized into first and second moving image data, said control unit comprising:
means for displaying an operation screen representing said plurality of moving image data on said display unit; and
means for specifying first moving image data for each of said plurality of moving image data displayed on said operation screen.

23. A moving image editing apparatus, comprising:
a display unit for displaying a plurality of moving image data; and
a control unit comprising:
an operation screen display control part that displays an operation screen representing said plurality of moving image data on said display unit; and
a user specification control part that specifies moving image data for each of said plurality of moving image data displayed on said operation screen as categorized to be first moving image data.

24. The moving image editing apparatus of claim 23, wherein said user specification control part further allows for specifying said moving image data as categorized to be second moving image data.

25. The moving image editing apparatus of claim 24, wherein one of said first moving image data and said second moving image data comprises desired moving image data and a remaining one of said first moving image data and said second moving image data comprises undesired moving image data.
